(19) United States
(12) Patent Application Publication
(10) Pub. No.: US 2026/0304173 A1
(43) Pub. Date: Oct. 1, 2026

(54) START AND STOP INDICATION FOR EVENT TRIGGERED DATA COLLECTION

(71) Applicant: QUALCOMM Incorporated, San Diego, CA (US)

(72) Inventors: Rajeev KUMAR, San Diego, CA (US); Aziz GHOLMIEH, Del Mar, CA (US)

(21) Appl. No.: 19/578,692

(22) Filed: Mar. 25, 2026

Related U.S. Application Data
(60) Provisional application No. 63/779,242, filed on Mar. 27, 2025.

(51) Int. Cl. H04W 24/08; H04W 72/23

(52) U.S. Cl. CPC H04W 24/08; H04W 72/23

(57) ABSTRACT

Certain aspects of the present disclosure provide techniques for indicating the start of event triggered data collection for artificial intelligence (AI) and/or machine learning (ML) model training scenarios. An example method, performed at a wireless node, generally includes obtaining first signaling configuring the wireless node to perform data collection responsive to detection of one or more events by the wireless node, wherein the first signaling configures the wireless node to perform the data collection according to a first configuration, detecting the one or more events, outputting second signaling indicating the detection, and performing the data collection according to the first configuration, subject to availability of processing resources at the wireless node.

### CROSS-REFERENCE TO RELATED APPLICATION(S)

This application claims benefit of and priority to Provisional Application No. 63/779,242, filed Mar. 27, 2025, which is hereby assigned to the assignee hereof and hereby expressly incorporated by reference herein in its entirety as if fully set forth below and for all applicable purposes.

### FIELD OF THE DISCLOSURE

Aspects of the present disclosure relate to wireless communications, and more particularly, to techniques for indicating the start of event triggered data collection for artificial intelligence (AI) and/or machine learning (ML) model training scenarios.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a wireless node. The method includes obtaining first signaling configuring the wireless node to perform data collection responsive to detection of one or more events by the wireless node, wherein the first signaling configures the wireless node to perform the data collection according to a first configuration; detecting the one or more events; outputting second signaling indicating the detection; and performing the data collection according to the first configuration, subject to availability of processing resources at the wireless node.

Another aspect provides a method for wireless communications at a first wireless node. The method includes outputting first signaling that configures a second wireless node to perform data collection responsive to detection of one or more events by the second wireless node, wherein the first signaling configures the second wireless node to perform the data collection according to a first configuration; and obtaining second signaling, from the second wireless node, indicating detection of at least one of the events.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates example beam refinement procedures, in accordance with certain aspects of the present disclosure.

FIG. 6 is a diagram illustrating example operations where beam management may be performed.

FIG. 7 illustrates a general functional framework applied for AI-enabled RAN intelligence.

FIG. 8 illustrates an example of spatial beam prediction.

FIG. 9 illustrates an example of temporal beam prediction.

FIGS. 10-14 depict example CPU occupation durations for different cases.

FIG. 15 depicts an example of event-triggered data collection.

FIG. 16 depicts a call flow diagram illustrating an example of start and stop signaling, in accordance with certain aspects of the present disclosure.

FIG. 17 depicts a call flow diagram illustrating an example of start and stop signaling, in accordance with certain aspects of the present disclosure.

FIG. 18 depicts a call flow diagram illustrating an example of start and stop signaling, in accordance with certain aspects of the present disclosure.

FIG. 19 depicts a call flow diagram illustrating an example of start and stop signaling, in accordance with certain aspects of the present disclosure.

FIG. 20 depicts a call flow diagram illustrating an example of start and stop signaling, in accordance with certain aspects of the present disclosure.

FIG. 21 depicts a call flow diagram illustrating an example of priority based data collection, in accordance with certain aspects of the present disclosure.

FIG. 22 depicts a method for wireless communications.

FIG. 23 depicts a method for wireless communications.

FIG. 24 depicts aspects of an example communications device.

### DETAILED DESCRIPTION

Aspects of the present disclosure provide signaling mechanisms for a user equipment (UE) to indicate the start and/or stop of event triggered data collection for network-side artificial intelligence (AI) and/or machine learning (ML) model training scenarios.

Machine learning (ML) generally refers to a subset of artificial intelligence (AI) that involves algorithms and models that enable computers/processors to learn from and make predictions or decisions based on data. ML typically focuses on creating systems that can improve their performance on a specific task by recognizing patterns and making adjustments through iterative learning, without being explicitly programmed. Machine learning is used in various applications, including image and speech recognition, recommendation systems, and predictive analytics.

ML may be deployed to perform certain functions in certain wireless communications systems, such as signal processing (referred to as beamforming or beam steering) to steer wireless signals in a certain direction of a beam. In such systems, two or more wireless devices may perform a beam management procedure to select a beam with which to communicate. For beam management purposes, a network entity may configure a user equipment (UE) with a set of resources for channel measurements, which may be referred to as channel measurement resources (CMRs). The network entity may transmit one or more RSs to the UE on the CMRs using a set of transmit beams. The UE may measure the reference signals to select a receive beam and to generate measurement reports for the beam management procedure.

In some cases, AI and/or ML models may be trained and used (e.g., at a network entity and/or a UE) to improve wireless communications. For example, ML models may be used to perform temporal beam prediction and/or spatial beam prediction (e.g., prediction for a set of beams, Set-A, based on measurements of a different set of beams, Set-B). For example, such a model may predict channel characteristics of Set-A beams based on measurement results (e.g., historic measurement results) of Set-B beams (e.g., where Set-A beams are narrower than Set-B beams). Such beam prediction may be performed by a model at the network entity and/or a UE.

In some cases, AI/ML models may be trained at a network entity, based on data collected by a UE. A UE may perform such data collection based on channel state information (CSI) RS measurements, which may consume processing resources at the UE referred to as CSI processing units (CPUs). In this context, a CPU generally refers to a processing unit responsible for handling CSI reporting. CPUs may be considered occupied for defined durations during CSI-RS measurement and reporting.

A UE is generally limited in how many CPUs it supports, which generally translates to a number of CSI calculations the UE can make. For example, if a UE supports N CPUs, if L CPUs are occupied for calculation of CSI measurements or reports in a given period of time, the UE has N-L unoccupied CPUs. The network, thus, tracks a UE's CPU occupancy to make sure the UE has sufficient CPU availability for measurements or reporting, for example, before configuring the UE for data collection based on a certain configuration.

In some cases, the network may configure a UE with event-triggered data collection, logging, and reporting (e.g., via measurement objects and reporting configurations). Events for data collection logging and reporting are checked at the UE and, when detected, the UE starts data collection. The events may include any configured measurement, condition, or trigger used to initiate data collection. Typical event triggers may involve a serving or neighboring cell and may include threshold crossing, serving cell improvement/degradation, a neighbor/beam becoming better, a beam index change, a CSI change, or a resource-specific quality change.

Unfortunately, for event-trigger data collection, the network may not be aware when event-trigger data collection logging starts and stops at the UE. Thus, the network may not be aware which measurement object (e.g., as indicated by a CSI resource configuration ID-CSI-ResourceConfigID or identifier of configuration provided for data collection measurements and logging) is used for data collection logging. Without this information, the network may not be aware about CPU usage for data collection for network side model training, which may adversely impact how the network handles activation/deactivation of CSI report configurations.

Aspects of the present disclosure, however, provide signaling mechanisms that allow a UE to indicate the start and/or stop of event triggered data collection logging. As a result, the network may be able to better track CPU usage at the UE and can better know how to handle activation/deactivation of other CSI report configurations.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

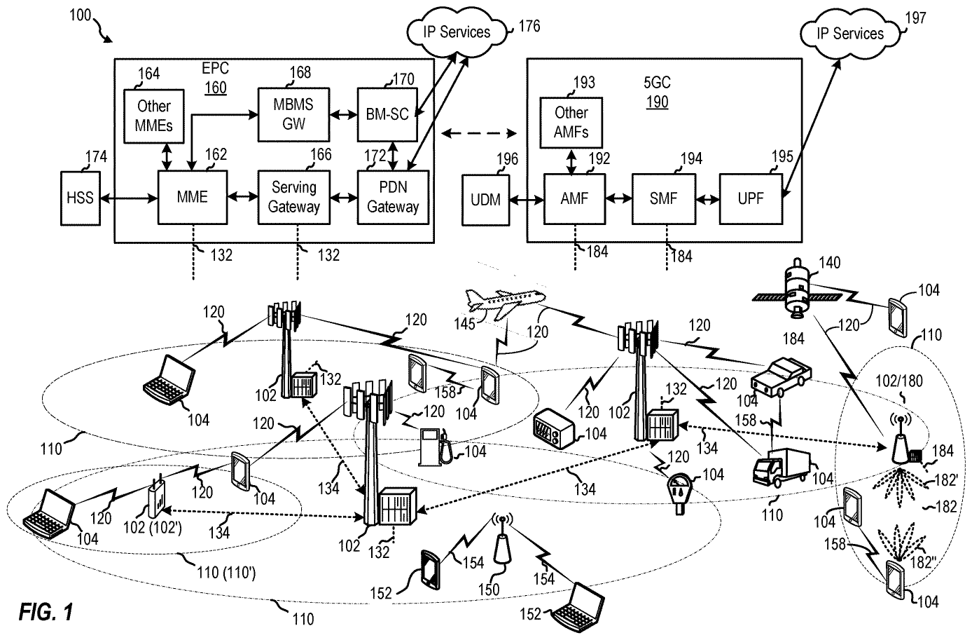

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

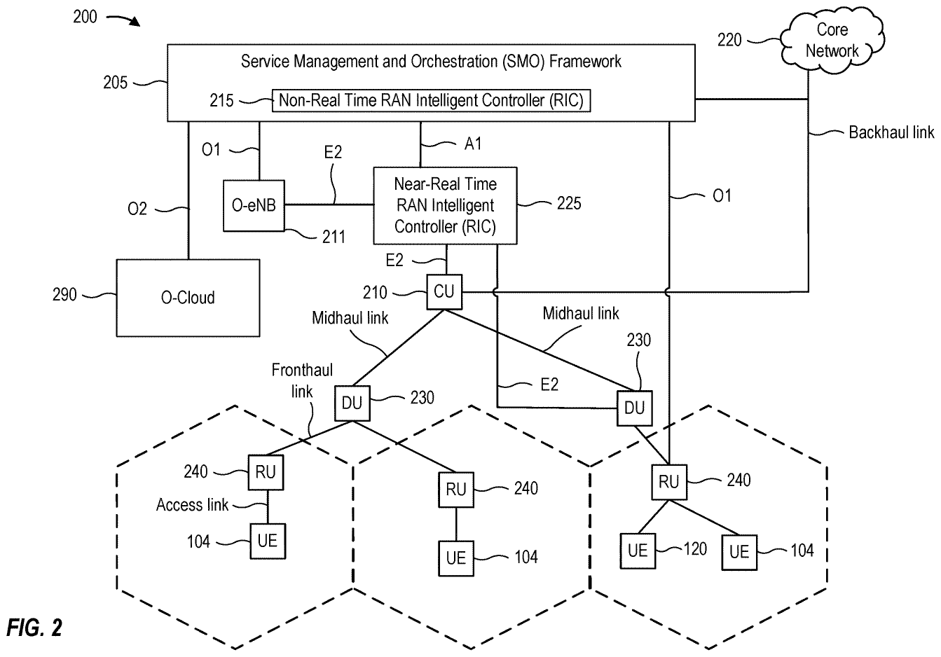

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5GNR orNext Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (Start/StopStart/StopStart/Stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

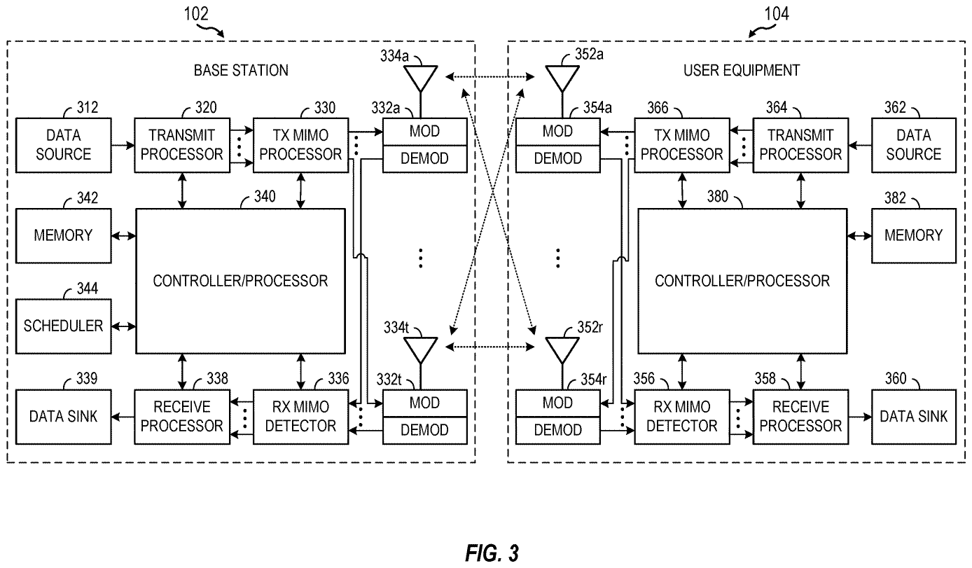

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

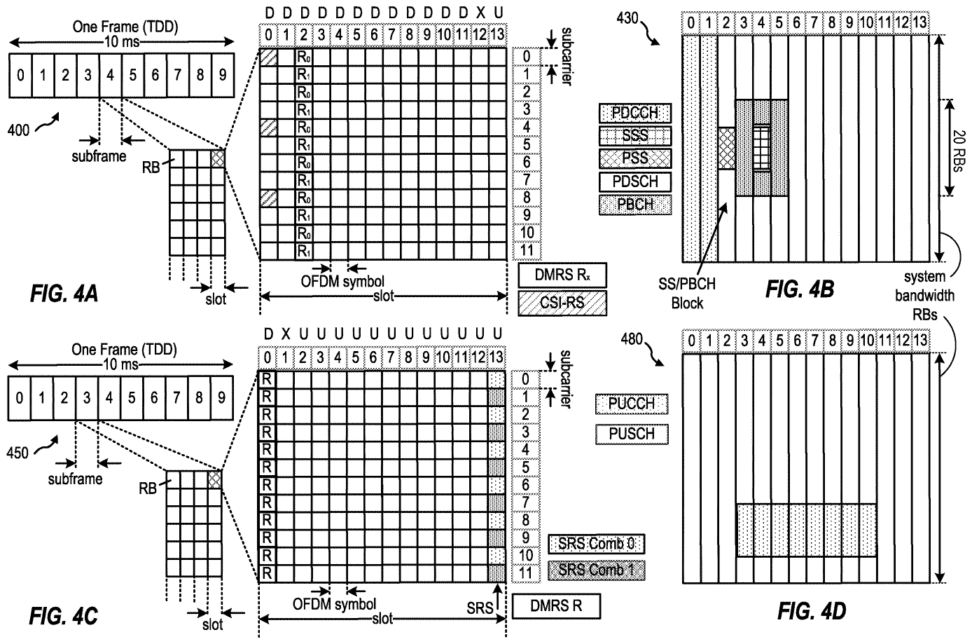

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Beam Refinement Procedures

In mmWave systems, beam forming may be important to overcome high path-losses. As described herein, beamforming may refer to establishing a link between a BS and UE, wherein both of the devices form a beam corresponding to each other. Both the BS and the UE find at least one adequate beam to form a communication link. BS-beam and UE-beam form what is known as a beam pair link (BPL). As an example, on the DL, a BS may use a transmit beam and a UE may use a receive beam corresponding to the transmit beam to receive the transmission. The combination of a transmit beam and corresponding receive beam may be a BPL.

As a part of beam management, beams which are used by BS and UE have to be refined from time to time because of changing channel conditions, for example, due to movement of the UE or other objects. Additionally, the performance of a BPL may be subject to fading due to Doppler spread. Because of changing channel conditions over time, the BPL should be periodically updated or refined. Accordingly, it may be beneficial if the BS and the UE monitor beams and new BPLs.

At least one BPL has to be established for network access. As described above, new BPLs may need to be discovered later for different purposes. The network may decide to use different BPLs for different channels, or for communicating with different BSs (TRPs) or as fallback BPLs in case an existing BPL fails.

The UE typically monitors the quality of a BPL and the network may refine a BPL from time to time.

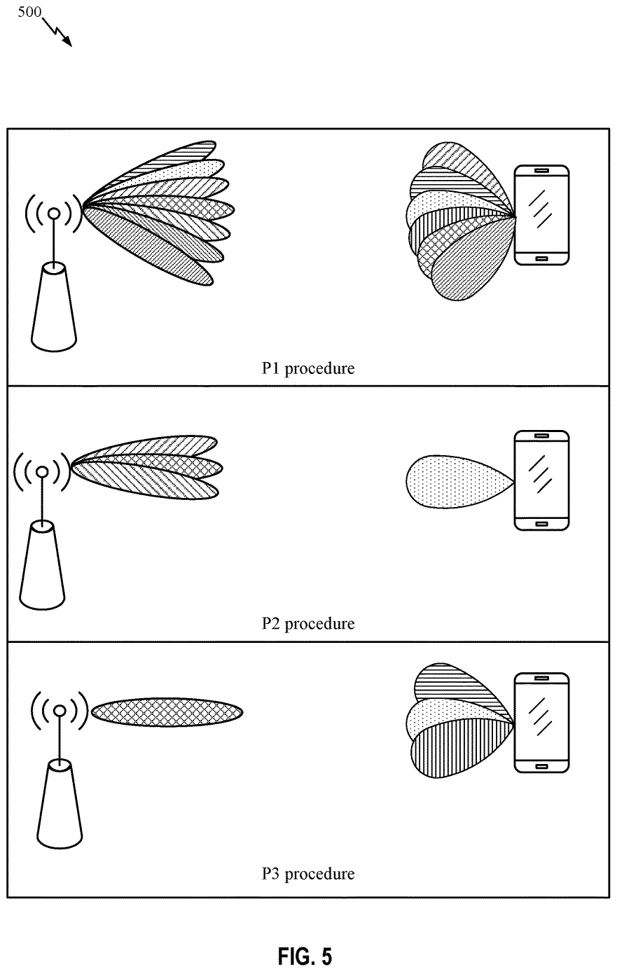

FIG. 5 illustrates example 500 for BPL discovery and refinement. In 5G-NR, the P1, P2, and P3 procedures are used for BPL discovery and refinement. The network uses a P1 procedure to enable the discovery of new BPLs. In the P1 procedure, as illustrated in FIG. 5, the BS transmits different symbols of a reference signal, each beam formed in a different spatial direction such that several (e.g., most or all) relevant places of the cell are reached. Stated otherwise, the BS transmits beams using different transmit beams over time in different directions.

For successful reception of at least a symbol of this “P1-signal”, the UE has to find an appropriate receive beam. It searches using available receive beams and applying a different UE-beam during each occurrence of the periodic P1-signal.

Once the UE has succeeded in receiving a symbol of the P1-signal it has discovered a BPL. The UE may not want to wait until it has found the best UE receive beam, since this may delay further actions. The UE may measure the reference signal receive power (RSRP) and report the symbol index together with the RSRP to the BS. Such a report will typically contain the findings of one or more BPLs.

In an example, the UE may determine a received signal having a high RSRP. The UE may not know which beam the BS used to transmit; however, the UE may report to the BS the time at which it observed the signal having a high RSRP. The BS may receive this report and may determine which BS beam the BS used at the given time.

The BS may then offer P2 and P3 procedures to refine an individual BPL. The P2 procedure refines the BS-beam of a BPL. For example, the BS may transmit a few symbols of a reference signal with different BS-beams that are spatially close to the BS-beam of the BPL (the BS performs a sweep using neighboring beams around the selected beam). In P2, the UE keeps its beam constant. Thus, while the UE uses the same beam as in the BPL (as illustrated in P2 procedure in FIG. 5). The BS-beams used for P2 may be different from those for P1 in that they may be spaced closer together or they may be more focused. The UE may measure the RSRP for the various BS-beams and indicate the best one to the BS.

The P3 procedure refines the UE-beam of a BPL (see P3 procedure in FIG. 5). While the BS-beam stays constant, the UE scans using different receive beams (the UE performs a sweep using neighboring beams). The UE may measure the RSRP of each beam and identify the best UE-beam. Afterwards, the UE may use the best UE-beam for the BPL and report the RSRP to the BS.

Over time, the BS and UE establish several BPLs. When the BS transmits a certain channel or signal, it lets the UE know which BPL will be involved, such that the UE may tune in the direction of the correct UE receive beam before the signal starts. In this manner, every sample of that signal or channel may be received by the UE using the correct receive beam. In an example, the BS may indicate for a scheduled signal (e.g., SRS, CSI-RS) or channel (e.g., PDSCH, PDCCH, PUSCH, PUCCH) which BPL is involved. In NR, this information may be referred to as a quasi co-location (QCL) indication.

Two antenna ports are quasi co-located (QCL) if properties of the channel over which a symbol on one antenna port is conveyed may be inferred from the channel over which a symbol on the other antenna port is conveyed. QCL supports, at least, beam management functionality, frequency/timing offset estimation functionality, and radio resource management (RRM) functionality.

The BS may use a BPL which the UE has received in the past. The transmit beam for the signal to be transmitted and the previously-received signal both point in a same direction or are QCL. The QCL indication may be needed by the UE (in advance of signal to be received) such that the UE may use a correct receive beam for each signal or channel. Some QCL indications may be needed from time to time when the BPL for a signal or channel changes and some QCL indications are needed for each scheduled instance. The QCL indication may be transmitted in the downlink control information (DCI), which may be part of the PDCCH channel. Because DCI is needed to control the information, it may be desirable that the number of bits needed to indicate the QCL is not too large. The QCL may be transmitted in a medium access control-control element (MAC-CE) or radio resource control (RRC) message.

According to one example, whenever the UE reports a BS beam that it has received with sufficient RSRP, and the BS decides to use this BPL in the future, the BS assigns it a BPL tag. Accordingly, two BPLs having different BS beams may be associated with different BPL tags. BPLs that are based on the same BS beams may be associated with the same BPL tag. Thus, according to this example, the tag is a function of the BS beam of the BPL.

As noted above, wireless systems, such as millimeter wave (mmW) systems, bring gigabit speeds to cellular networks, due to availability of large amounts of bandwidth. However, the unique challenges of heavy path-loss faced by such wireless systems necessitate new techniques such as hybrid beamforming (analog and digital), which are not present in 3G and 4G systems. Hybrid beamforming may enhance link budget/signal to noise ratio (SNR) that may be exploited during the RACH.

In such systems, the node B (NB) and the user equipment (UE) may communicate over active beam-formed transmission beams. Active beams may be considered paired transmission (transmit) and reception (receive) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

Since the direction of a reference signal is unknown to the UE, the UE may evaluate several beams to obtain the best receive beam for a given NB transmit beam. However, if the UE has to “sweep” through all of its receive beams to perform the measurements (e.g., to determine the best receive beam for a given NB transmit beam), the UE may incur significant delay in measurement and battery life impact. Moreover, having to sweep through all receive beams is highly resource inefficient. Thus, aspects of the present disclosure provide techniques to assist a UE when performing measurements of serving cells and neighbor cells when using receive beamforming.

### Example Beam Management

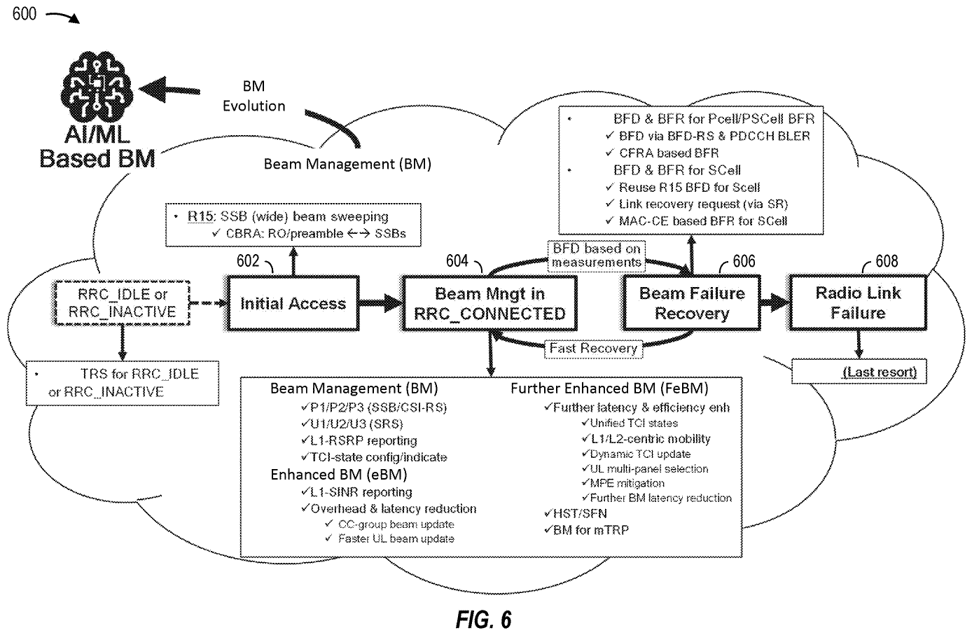

In wireless communications, various procedures may be performed for beam management. FIG. 6 is a diagram illustrating example operations where beam management may be performed. In initial access 602, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention-based Random Access (CBRA) procedure).

In connected mode 604, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 606, which may allow a UE to return to connected mode 604 without performing a radio link failure procedure 608. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 608 (e.g., a RACH procedure) to recover from the radio link failure.

### Example Framework for AI/ML in a Radio Access Network

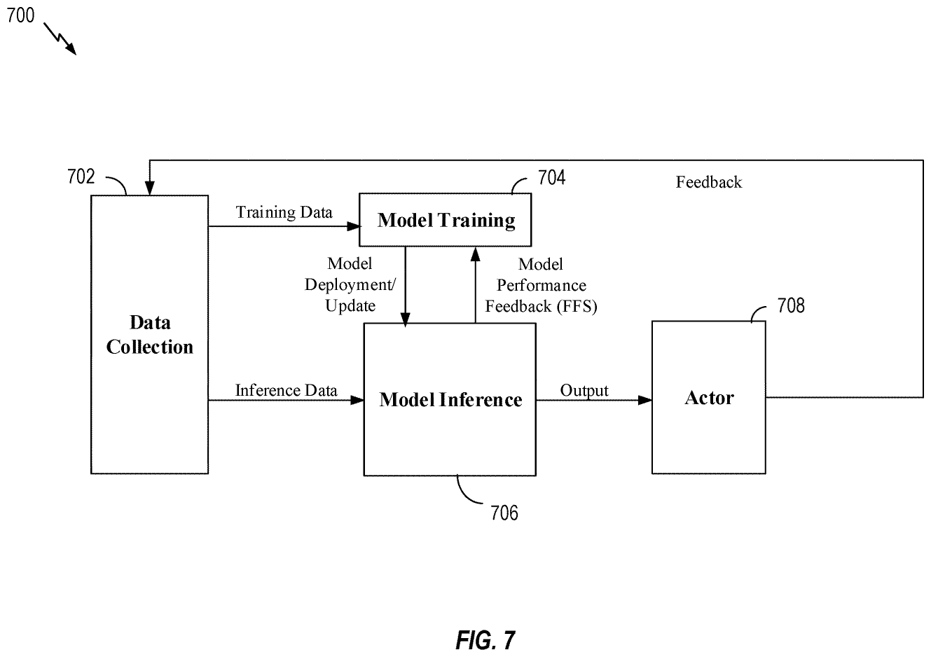

FIG. 7 depicts an example of AI/ML functional framework 700 for RAN intelligence, in which aspects described herein may be implemented.

The AI/ML functional framework includes a data collection function 702, a model training function 704, a model inference function 706, and an actor function 708, which interoperate to provide a platform for collaboratively applying AI/ML to various procedures in RAN.

The data collection function 702 generally provides input data to the model training function 704 and the model inference function 706. AI/ML algorithm specific data preparation (e.g., data pre-processing and cleaning, formatting, and transformation) may not be carried out in the data collection function 702.

Examples of input data to the data collection function 702 (or other functions) may include measurements from UEs or different network entities, feedback from the actor function, and output from an AI/ML model. In some cases, analysis of data needed at the model training function 704 and the model inference function 706 may be performed at the data collection function 702. As illustrated, the data collection function 702 may deliver training data to the model training function 704 and inference data to the model inference function 706.

The model training function 704 may perform AI/ML model training, validation, and testing, which may generate model performance metrics as part of the model testing procedure. The model training function 704 may also be responsible for data preparation (e.g., data pre-processing and cleaning, formatting, and transformation) based on the training data delivered by the data collection function 702, if required.

The model training function 704 may provide model deployment/update data to the Model inference function 706. The model deployment/update data may be used to initially deploy a trained, validated, and tested AI/ML model to the model inference function 706 or to deliver an updated model to the model inference function 706.

As illustrated, the model inference function 706 may provide AI/ML model inference output (e.g., predictions or decisions) to the actor function 708 and may also provide model performance feedback to the model training function 704, at times. The model inference function 706 may also be responsible for data preparation (e.g., data pre-processing and cleaning, formatting, and transformation) based on inference data delivered by the data collection function 702, at times.

The inference output of the AI/ML model may be produced by the model inference function 706. Specific details of this output may be specific in terms of use cases. The model performance feedback may be used for monitoring the performance of the AI/ML model, at times. In some cases, the model performance feedback may be delivered to the model training function 704, for example, if certain information derived from the model inference function is suitable for improvement of the AI/ML model trained in the model training function 704.

The model inference function 706 may signal the outputs of the model to nodes that have requested them (e.g., via subscription), or nodes that take actions based on the output from the model inference function. An AI/ML model used in a model inference function 706 may need to be initially trained, validated and tested by a model training function before deployment. The model training function 704 and model inference function 706 may be able to request specific information to be used to train or execute the AI/ML algorithm and to avoid reception of unnecessary information. The nature of such information may depend on the use case and on the AI/ML algorithm.

The actor function 708 may receive the output from the model inference function 706, which may trigger or perform corresponding actions. The actor function 708 may trigger actions directed to other entities or to itself. The feedback generated by the actor function 708 may provide information used to derive training data, inference data or to monitor the performance of the AI/ML Model. As noted above, input data for a data collection function 702 may include this feedback from the actor function 708. The feedback from the actor function 708 or other network entities (e.g., via a Data Collection function) may also be used at the model inference function 706.

The AI/ML functional framework 700 may be deployed in various RAN intelligence-based use cases. Such use cases may include CSI feedback enhancement, enhanced beam management (BM), positioning and location (Pos-Loc) accuracy enhancement, and various other use cases.

### Overview of AI/ML Based Beam Management

AI/ML-based beam management (BM) may help improve beam selection accuracy, reduce overhead and latency, and enhance overall performance by leveraging AI/ML models for tasks like beam prediction and optimization. AI/ML-based BM may be significantly more efficient than traditional beam management methods (e.g., described above with reference to FIG. 5) that rely on exhaustive beam sweeping, which has significant latency and power consumption.

ML-based BM algorithms may be used to predict the best beam pair (transmit and receive beams) based on channel measurements, reducing the need for exhaustive sweeping and improving efficiency. In other words, ML-based BM may reduce reference signal (RS) overhead and UE power consumption by using prediction to replace certain measurements.

Often, the concept of two sets of beams, Set A and Set B beams, are used for ML-based BM. In this context, set B beams are associated with actual measurements and used as AI/ML inputs, while set A beams are considered prediction targets, whose predicted characteristics are derived based on AI/MNL outputs.

There are various BM use cases, including spatial beam prediction (BM-Case 1) and temporal beam prediction (BM-Case 2). In some cases, spatial beam prediction and temporal beam prediction may be combined (to achieve spatio-temporal beam prediction).

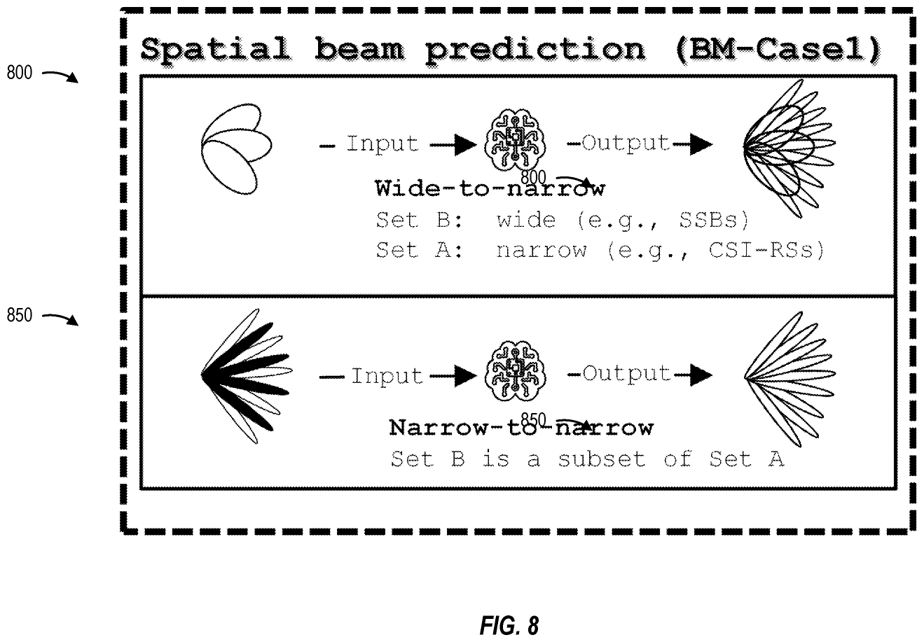

FIG. 8 illustrates examples of spatial beam prediction. As illustrated, AI/ML models may be used to predict the best beam based on measurements from a subset of beams (Set B beams). In the first (top) example 800, a set of narrow (Set A) beams are predicted based on measurements of a set of wider (Set B) beams. In the second (bottom) example 850, a set of narrow (Set A) beams are predicted based on measurements of a set of narrow (Set B) beams.

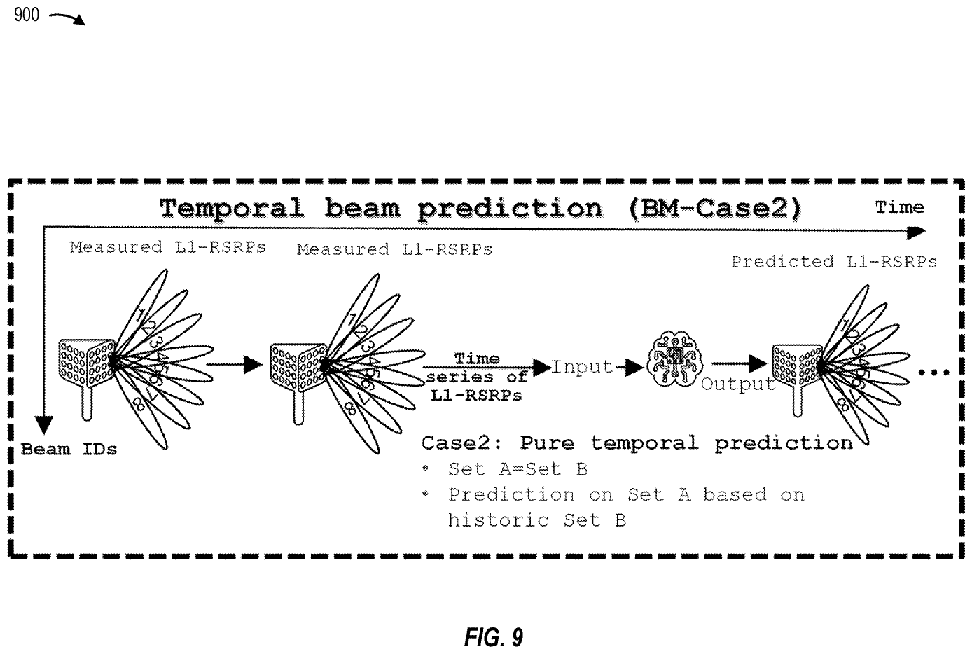

As illustrated in example 900 of FIG. 9, temporal beam prediction uses AI/ML models to predict the measurements of certain beams at a future time instant based on historical measurements. As illustrated, measurements of Set A beams are predicted based on a time series of measurements taken for Set B beams.

### Overview of CSI Processing Unit (CPU) Occupation

In some cases, AI/ML models may be trained at a network entity, based on data collected by a UE. A UE may perform such data collection based on channel state information (CSI) RS measurements, which may consume processing resources at the UE referred to as CSI processing units (CPUs). In this context, a CPU generally refers to a processing unit responsible for handling measurements on CSI resource or resource sets and reporting of measurement using PUCCH or PUSCH. CPUs may be considered occupied for defined durations during CSI-RS measurement and reporting.

A UE is generally limited in how many CPUs it supports, which generally translates to a number of CSI calculations the UE can make. Thus, the UE may report CPU related information as a UE capability.

For example, a UE may report a number N_CPU of simultaneous CSI calculations (#CPUs) supported per component carrier (CC) and/or a total number for all CCs. In general, if L CPUs are occupied for calculation of CSI reports in a given OFDM symbol, the UE has N_CPU-L unoccupied CPUs. A UE can refrain from updating the N-M requested CSI reports that have a lowest priority where:
N CSI reports start occupying their respective CPUs on the same OFDM symbol on which N_{CPU}-L CPUs are unoccupied. Each such CSI report n=0, . . . , N−1 should occupy

$${O}_{C P U}^{( n )}$$

CPUs. 0≤M≤N is the largest value such that

$${\sum }_{n = 0}^{M - 1} {O}_{C P U}^{( n )} \leq {N}_{C P U} - L$$

holds.

The number of different CSI report settings comprised by a single AP CSI triggering state should not be greater than N_CPU. A parameter O_CPU may track the number of occupied CPUs. For example, O_CPU=0, if a report quantity of the corresponding CSI report setting is set to none while the CSI Resource Set associated with the CSI report setting is configured with a parameter trs-Info. O_CPU=1, if a report quantity of the corresponding CSI report setting is set to cri-RSRP or ssb-Index-RSRP or cri-SINR or ssb-Index-SINR, or none while the CSI Resource Set associated with the CSI report setting is NOT configured with trs-Info. O_CPU=Ks, if the report quantity of the corresponding CSI report setting is set to cri-RI-PMI-CQI or cri-RI-iI or cri-RI-iI-CQI or cri-RI-CQI or cri-RI-LI-PMI-CQI, where Ks is the number of CSI-RS resources in the associated Channel Measurement Resource (CMR) Set.

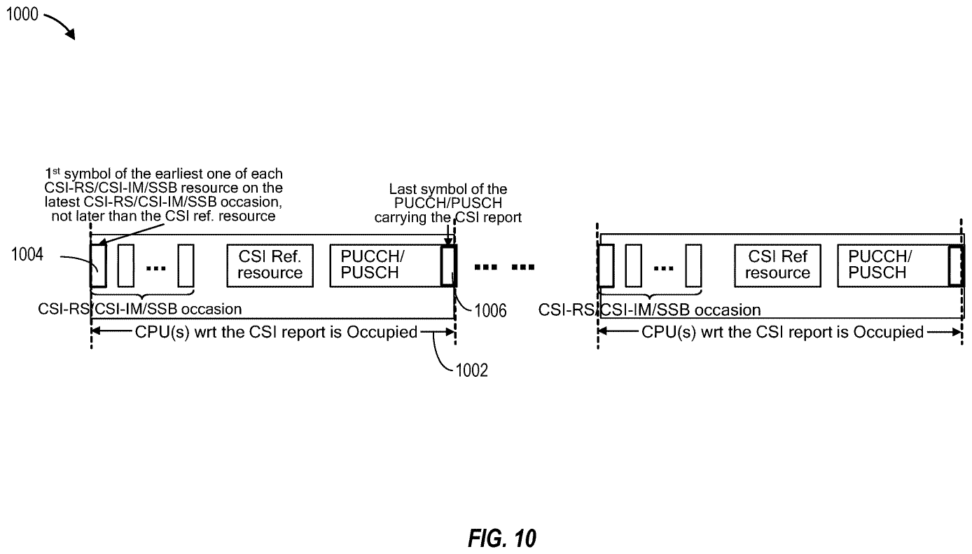

FIGS. 10-12 illustrate examples of CPU occupation duration for particular scenarios and example cases, where report quantity is NOT set to none.

As illustrated in diagram 1000 FIG. 10, for a first case (Case #1), for periodic (P) or semi-persistent (SP) CSI reports (excluding the initial SP CSI report on PUSCH after the PDCCH triggering the report; also excluding typeII-Doppler PMI associated SP CSI reports), the CPU(s) occupation duration 1002 may be from the 1st symbol 1004 of the earliest one of each CSI-RS, CSI interference measurement (CSI-IM) or SSB resource associated with a CSI-ReportConfig, on the latest CSI-RS/CSI-IM/SSB occasion no later than the corresponding CSI reference resource, until the last symbol 1006 of the configured PUSCH/PUCCH carrying the CSI report.

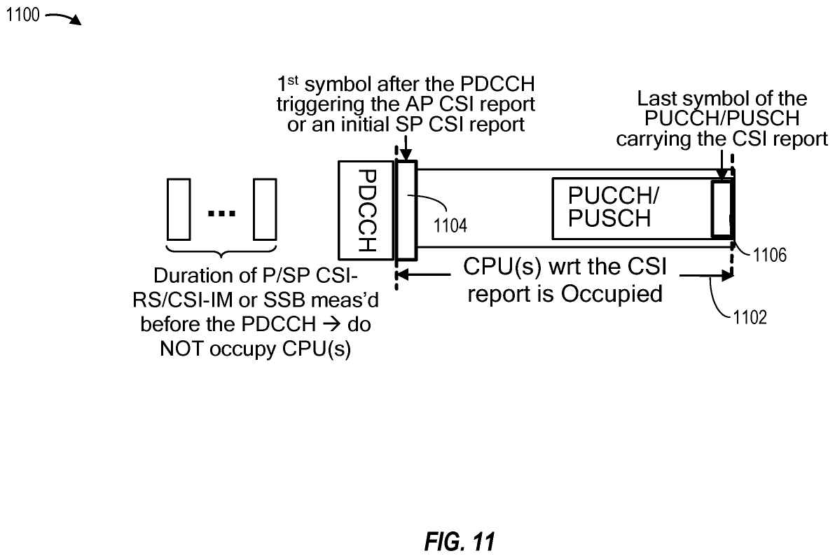

As illustrated in diagram 1100 FIG. 11, for a second case (Case #2), for aperiodic (AP) CSI reports, or an initial SP CSI report on PUSCH triggered by DCI, the CPU(s) occupation duration 1102 may be from the 1st symbol 1104 after the PDCCH triggering the CSI report until the last symbol 1106 of the scheduled PUSCH carrying the report.

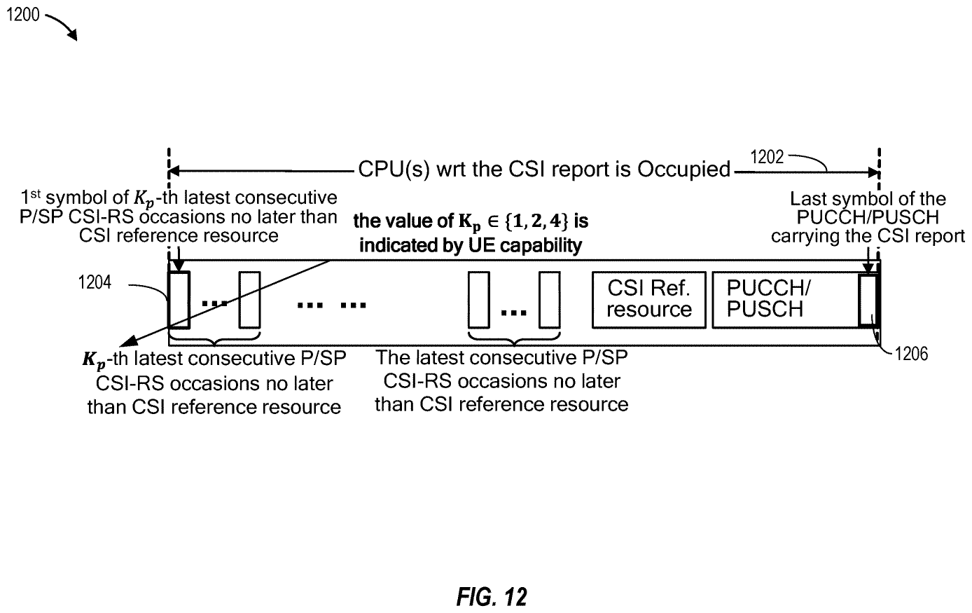

As illustrated in diagram 1200 FIG. 12, for a third case (Case #3), for SP CSI reports (e.g., for typeII-Doppler PMI CSI reports (codebookType within a CSI-ReportConfig is set to typeII-Doppler-r18 or typeII-Doppler-PortSelection-r18)), CPU(s) occupation duration 1202 may be from the 1st symbol 1204 of K_p-th latest consecutive P/SP CSI-RS occasions no later than CSI reference resource, until the last symbol 1206 of the PUSCH carrying the report, where the value of K_p∈{1,2,4} is indicated by UE capability.

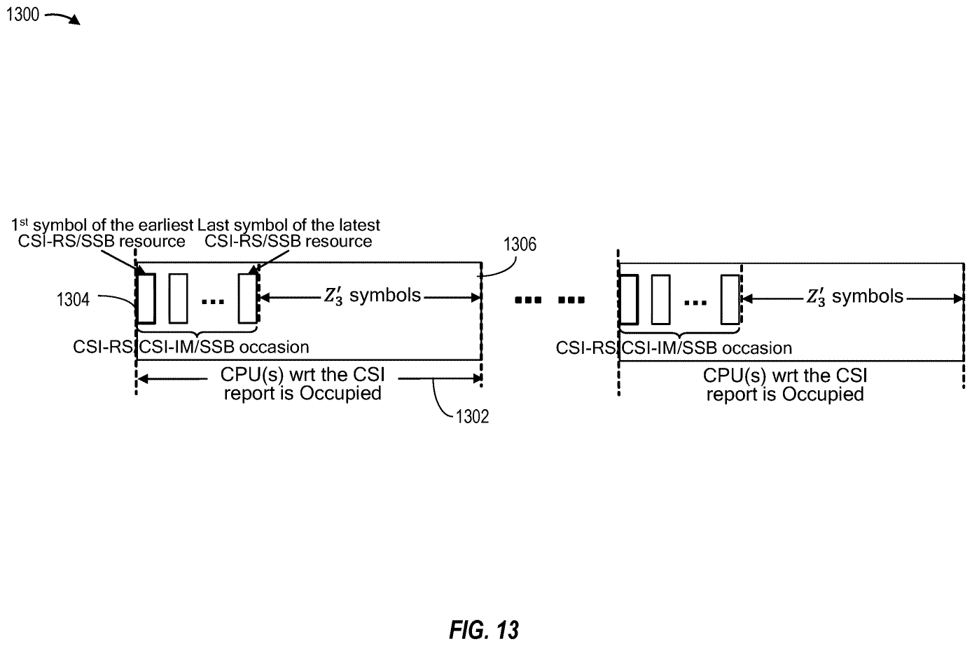

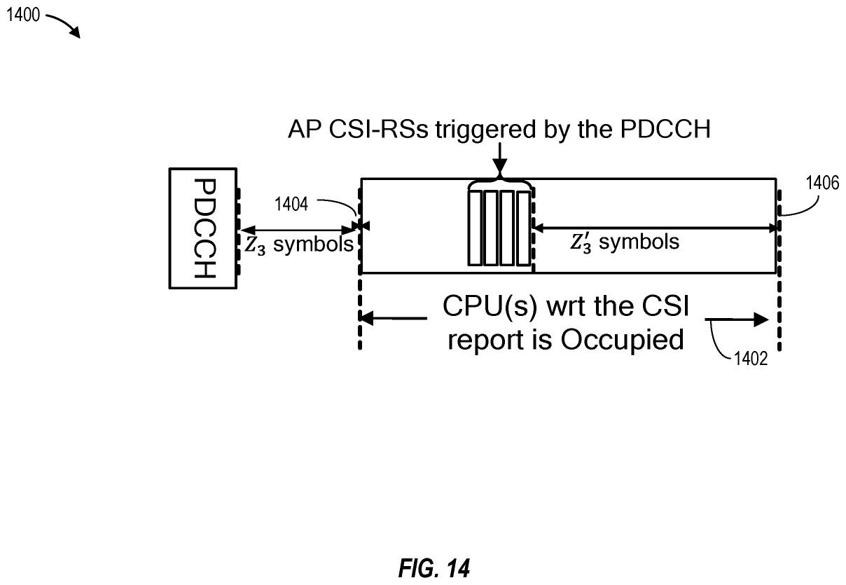

FIGS. 13-14 illustrate examples of CPU occupation duration for particular scenarios and example cases, where reportQuantity is set to none and trs-info not configured for the CMR set.

As illustrated in diagram 1300 FIG. 13, for a first case (Case #1), for SP CSI reports (excluding the initial SP CSI report on PUSCH after the PDCCH triggering the report), CPU(s) occupation duration 1302 may be from the first symbol 1304 of the earliest one of each transmission occasion of periodic or semi-persistent CSI-RS/SSB resource for channel measurement for L1-RSRP computation, until a time 1306 Z′₃ symbols after the last symbol of the latest one of the CSI-RS/SSB resource for channel measurement for L1-RSRP computation in each transmission occasion.

As illustrated in diagram 1400 FIG. 14, for a second case (Case #1), for AP CSI reports, CPU(s) occupation duration 1402 from the first symbol after the PDCCH triggering the CSI report until the last symbol between a first point 1404 Z₃ symbols after the first symbol after the PDCCH triggering the CSI report and a second point 1406 Z′₃ symbols after the last symbol of the latest one of each CSI-RS/SSB resource for channel measurement for L1-RSRP computation.

A value for

$${Z}_{3}^{′}$$

and the corresponding value of Z₃ are defined by a table, where Z₃ is the # of symbols after the end of the last symbol of the PDCCH triggering the AP CSI report and

$${Z}_{3}^{′}$$

is the # of symbols after the end of the last symbol of the latest of: AP CSI-RS resource for channel measurements, AP CSI-IM used for interference measurements, and AP NZP CSI-RS for interference measurements. The values of Z₃ and Z′₃ may depend on values of parameters {X₁, X₂, . . . , X₆} and {KB₁, . . . , KB₄} that are UE reported capabilities for beam reporting delay and beam switching delay, with respect to different subcarrier spacings (SCSs).

### Aspects Related to Start Stop Indication for Event Triggered Data Collection for NW-Side Model Training

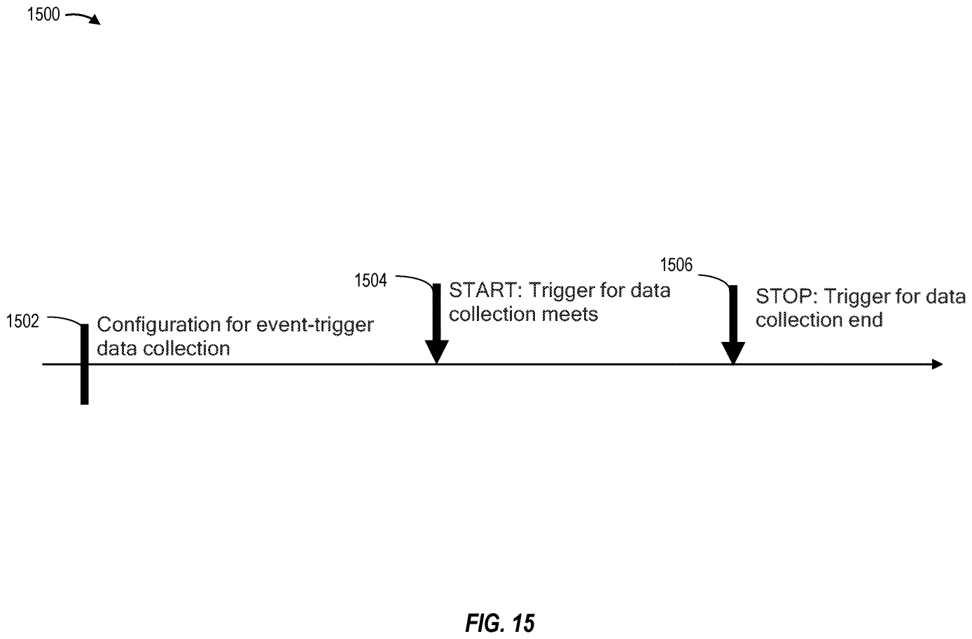

As previously noted, the network may configure a UE with event-triggered data collection, logging, and reporting (e.g., via CSI resource or resource set measurement objects, logging configuration, and reporting configurations). For example, diagram 1500 of FIG. 15 shows an example where the network configured a UE for event-triggered data collection at time 1502. At time 1504, the UE detects one of the configured events and starts data collection. The UE performs data collection and logging of measurements until stopping point 1506.

As noted, when the network configures a UE with event-triggered data collection, logging, and reporting, the network may not be aware when event-trigger data collection logging starts and stops at the UE. Furthermore, the network may not be aware which measurement object (e.g., CSI-ResourceConfigID or identifier of configuration provided for data collection measurements and logging identifier) is used for data collection logging when event is triggered. Without this information, the network may not be aware about CPU usage for data collection for network side model training, which may adversely impact how the network handles activation/deactivation of other CSI report configurations.

Aspects of the present disclosure, however, provide signaling mechanisms that allow a UE to indicate the start and/or stop of event triggered data collection. As a result, the network may be able to better track CPU usage at the UE and can better know how to handle activation/deactivation of CSI report configurations (for data collection measurements and logging, legacy CSI report configuration for L1 beam measurements, PMI reporting, and others, or CSI report configuration AI/ML inference or monitoring for different UE features or feature groups). In some cases, after event detection, a UE may transmit an explicit indication of the detection. In some cases, the UE may transmit an identifier (ID) of a configuration (e.g., a CSI-ResourceConfigID or other identifier of configuration provided for data collection measurements and logging) or a measurement ID (e.g., associated with the CSI report configuration). In some cases, such indications may implicitly indicate a corresponding event was detected. In some cases, the UE may indicate that measurement initiation or suspension is requested for the the configuration and/or measurement ID.

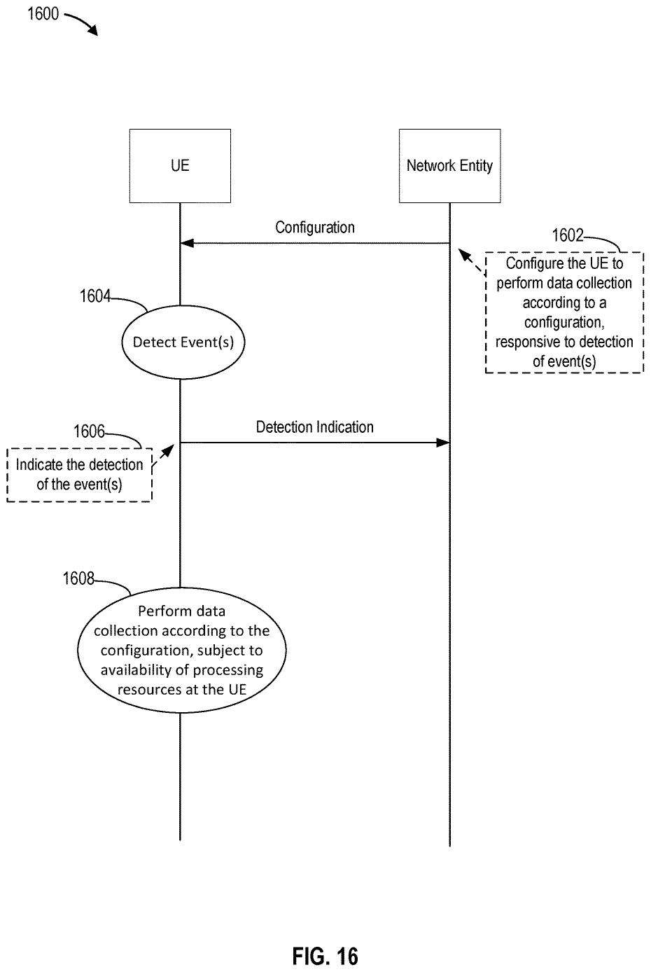

Start/stop signaling for event triggered data collection, in accordance with aspects of the present disclosure, may be understood with reference to call flow diagram 1600 of FIG. 16. In some aspects, the UE shown in FIG. 16 may be an example of the UE 104 depicted and described with respect to FIGS. 1 and 3. In some aspects, the network entity shown in FIG. 16 may be an example of the BS 102 (e.g., a gNB) depicted and described with respect to FIGS. 1 and 3 or a disaggregated base station depicted and described with respect to FIG. 2.

As illustrated at 1602, the network entity may configure the UE to perform data collection according to a configuration, responsive to detection of event(s). At 1604, the UE detects one of the events configured to trigger data collection.

As illustrate at 1606, the UE provides an indication of the detection to the network. As a result, the network may be aware of the start (e.g., or impending start) of data collection (e.g., and may track UE CPU occupancy accordingly). Provided there are sufficient processing resources (e.g., CPUs), at 1608, the UE may start performing data collection according to the configuration, subject to availability of processing resources at the UE. Additionally, the UE may indicate to the network if there is not sufficient CPU available for performing the measurements. Together with the start indication, the UE may indicate the identifier of CSI-ResourceConfig or identifier of a configuration provided for data collection measurements and logging.

Because of the indication provided by the UE, at 1606, the network may have knowledge about CPU usage for data collection for network side model training. Given this information, the network may know how to handle activation/deactivation of other CSI-report configurations. In some cases, by signaling both start and stop of event-triggered data collection, the network obtains visibility into CPU occupancy associated with specific configurations.

There are various options for how the UE signals the start and/or stop indications to the network, for example, depending on a particular network configuration (e.g., whether a non-split or split architecture).

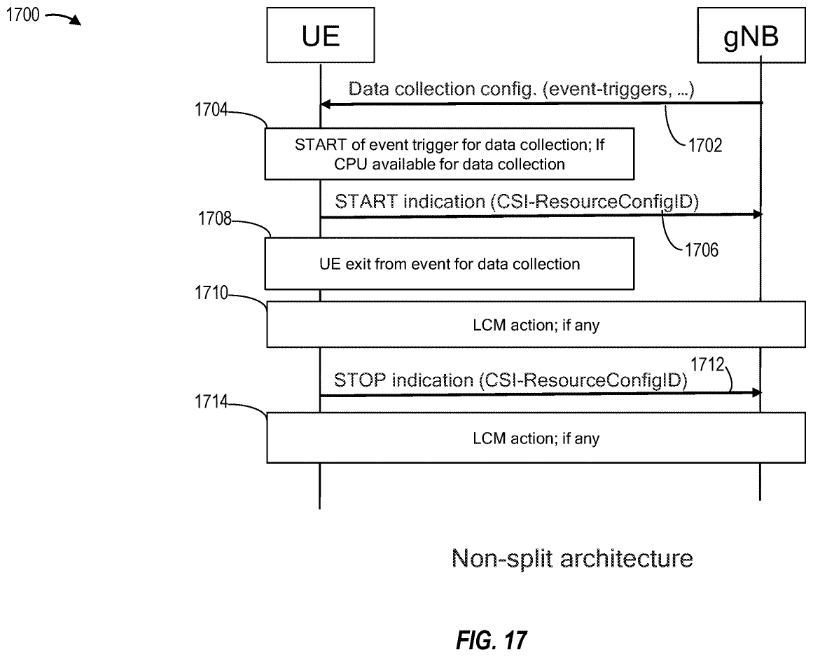

For example, call flow diagram 1700 of FIG. 17 shows an example of Start/StopStart/StopStart/Stop indication signaling for a non-split architecture.

As illustrated at 1702, the network configures the UE for data collection. At 1704, an event trigger is detected. The UE may start data collection if sufficient CPUs are available. At 1706, the UE sends an indication (that the event was detected and/or that data collection has started). As illustrated, the indication may include a CSI-ResourceConfigID or identifier of configuration provided for data collection measurements and logging). This indication may be provided to the network (gNB) via L1, L2, and/or L3 signaling. The network may, thus, take the UE CPU occupancy (due to data collection) into account for activating/deactivating/reconfiguring other CSI configurations.

According to certain aspects, if there is not enough CPU free cycles, the UE may additionally indicate that data collection is suspended (e.g., because sufficient CPUs are not available). In such cases, the network may choose to prioritize network measurements by reducing the current CPU occupancy at the UE. For example, the network may deconfigure data collection (e.g., event-trigger) or postpone the activation/deactivation of other CSI-reportConfig (e.g., if CPU budget at the UE has been met).

In some cases, the UE performs the data collection if the CPU is unoccupied (e.g., while the event trigger is TRUE), whether the network reconfigures or not. In some cases, if the UE could not perform data collection due to CPU issue, the UE may indicate timestamp (time range) when UE could not perform data collection due to CPU issue.

Once the UE exits from the event (at 1708), if the UE has sent the start indication, the UE may then send another indication to the network (at 1712) to indicate the event-trigger data collection STOP. In some cases, the network may send a request for the UE to report the data logged for the event-triggered data collection.

As indicated at 1710 and 1714, certain lifecycle management (LCM) actions may be taken in some cases, based on the indicated start and stop of data collection based on CSI-ResourceConfigID or identifier of a configuration provided for data collection measurements and logging. For example, various configurations may be updated based on data reported or events detected.

In some cases, the network may use the START and STOP indications for requesting data logged at the UE. In other words, after the network receives a STOP indication (following a START indication), the network may know the UE performed data collection and may request the corresponding logged data.

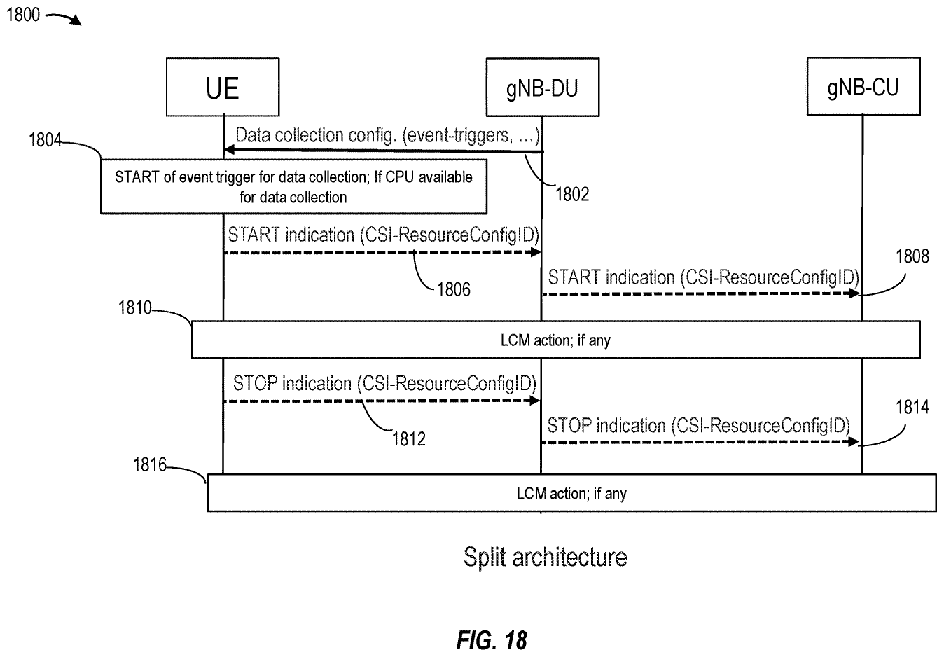

Call flow diagram 1800 of FIG. 18 shows an example of Start/StopStart/StopStart/Stop indication signaling for an example split architecture.

As illustrated at 1802, the network configures the UE for data collection. At 1804, an event trigger is detected. The UE may start data collection if sufficient CPUs are available. At 1806, the UE sends a Start indication (and CSI-ResourceConfigID or identifier of a configuration provided for data collection measurements and logging) to the gNB DU (that the event was detected and/or that data collection has started). This indication may be provided via L1 signaling, such as uplink control information (UCI), or L2 signaling, such as a medium access control (MAC) control element (CE).

As illustrated at 1808, the gNB-DU may forward the start indication and indicated CSI-ResourceConfigID or an identifier of a configuration provided for data collection measurements and logging to the gNB-CU (e.g., using inter-node signaling). Signaling of the CSI-ResourceConfigID or an identifier of a configuration provided for data collection measurements and logging may allow the gNB-CU to reconfigure data collection configuration, as necessary.

Once the UE exits from the event, if the UE has sent the start indication, the UE may then send another indication to the gNB-DU (at 1812) to indicate the event-trigger data collection STOP. At 1814, the gNB-DU may forward the stop indication to the gNB-CU and the CSI-ResourceConfigID or identifier of a configuration provided for data collection measurements and logging.

As indicated at 1810 and 1816, certain lifecycle management (LCM) actions may be taken in some cases, based on the indicated start and stop of data collection based on CSI-ResourceConfigID or an identifier of a configuration provided for data collection measurements and logging. For example, various configurations may be updated based on data reported or events detected.

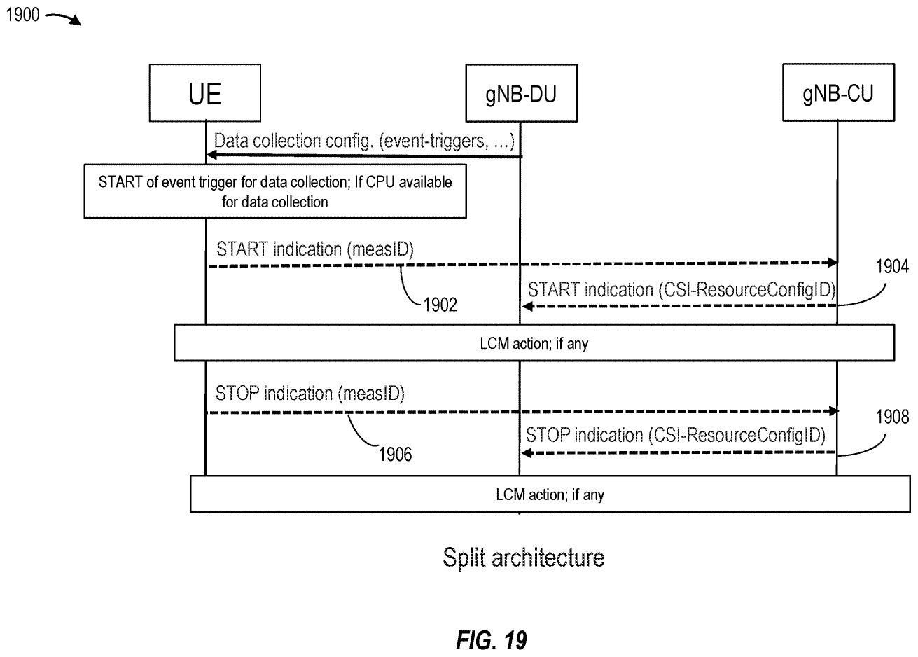

Call flow diagram 1900 of FIG. 19 shows another example of Start/StopStart/StopStart/Stop indication signaling for an example split architecture.

In this example, the UE may provide the start and stop indications to the network (gNB-CU) via L3 signaling.

In this case, at 1902, the UE may provide a Start indication that includes a measurement ID to the gNB-CU. for example, via UE assistance information (UAI). The gNB-CU may then provide an indication of a corresponding CSI-ResourceConfigID or an identifier of a configuration provided for data collection measurements and logging to the gNB-DU (e.g., via inter-node signaling), at 1904 (for the gNB-DU to be aware about CPU occupancy at the UE).

Similarly, at 1906, the UE may provide a Stop indication that includes a measurement ID (e.g., a configuration provided for data collection measurements and logging) to the gNB-CU, after exiting the triggering event. The gNB-CU may then provide an indication of a corresponding CSI-ResourceConfigID or an identifier of a configuration provided for data collection measurements and logging to the gNB-DU (e.g., via inter-node signaling), at 1908 (for the gNB-DU to be aware about CPU occupancy at the UE).

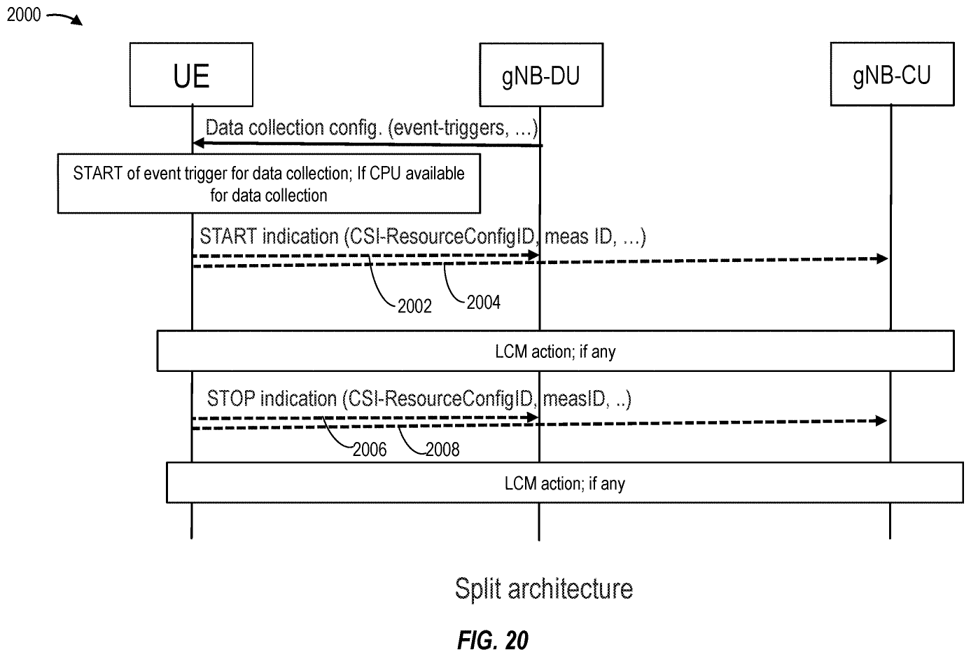

Call flow diagram 2000 of FIG. 20 shows another example of Start/StopStart/StopStart/Stop indication signaling for an example split architecture.

In this example, the UE may provide the start and stop indications to the network (gNB-CU) via a combination of L1/L2 and L3 signaling.

For example, the UE may send the Start indication to the gNB-DU via MAC-CE or UCI (at 2002) and to the gNB-CU using UAI (at 2004). Similarly, the UE may send the Stop indication to the gNB-DU via MAC-CE or UCI (at 2006) and to the gNB-CU using UAI (at 2008). As with previous examples, the indications may include the CSI-ResourceConfigID and/or measID and/or an identifier of a configuration provided for data collection measurements and logging, allowing the gNB-DU to be aware about CPU occupancy at the UE.

Similarly, at 2006, the UE may provide a Stop indication that includes a measurement ID to the gNB-CU, after exiting the triggering event. The gNB-CU may then provide an indication of a corresponding CSI-ResourceConfigID or an identifier of a configuration provided for data collection measurements and logging to the gNB-DU (e.g., via inter-node signaling), at 2008 (for the gNB-DU to be aware about CPU occupancy at the UE).

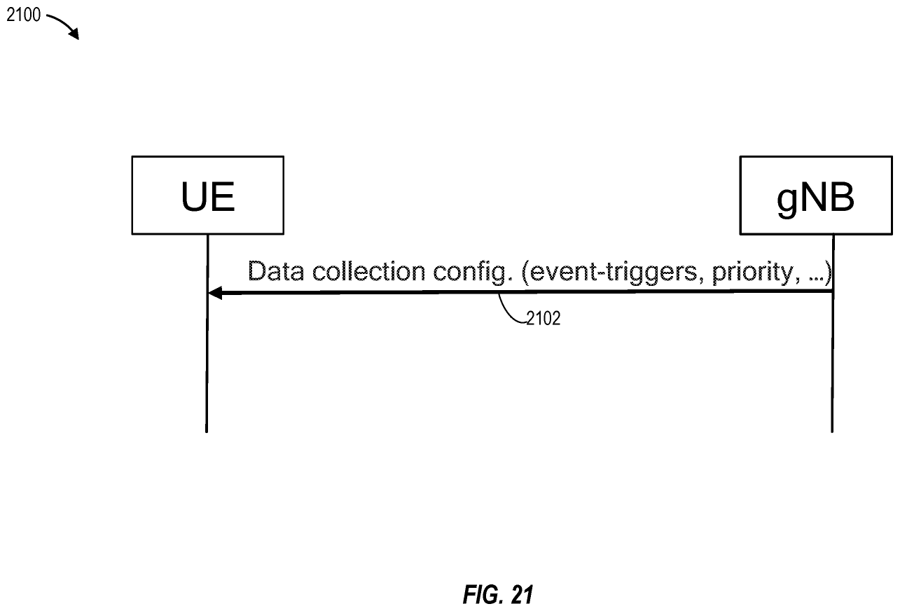

According to certain aspects, the UE may be configured to perform some type of priority-based handling. For example, as shown at 2102 in the example call flow 2100 of FIG. 21, different priorities are assigned may be assigned to different LCM actions (e.g., data collection for training, inference, and monitoring), when configuring the UE for data collection.

For example, priorities may be assigned to CSI-Reportconfigs for inference, CSI-Reportconfigs for monitoring, data collection configuration for training, and legacy CSI reportConfigs. For training data collection, the priorities may be provided, for example, per measurement configuration (e.g., measID) or per CSI-ResourceConfigID or an identifier of a configuration provided for data collection measurements and logging.

Based on the priorities, the UE may suspend the data collection for training (e.g., if it is assigned a low priority than other actions and there are not sufficient CPUs). In this case, however, the UE may opportunistically perform the data collection if a CPU (or CPUs) become unoccupied within the event trigger (while the event trigger is TRUE). In such cases, in the data collection report, the UE may indicate a timestamp (e.g., a time range) when the UE was not able to perform data collection due to CPU issue.

### Example Operations

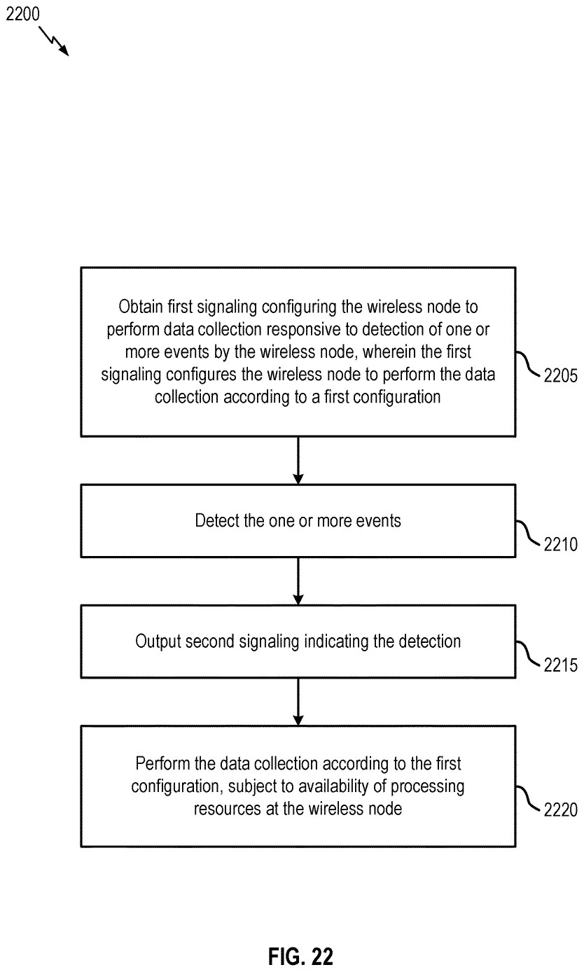

FIG. 22 shows an example of a method 2200 of wireless communications at a wireless node, such as a UE 104 of FIGS. 1 and 3.

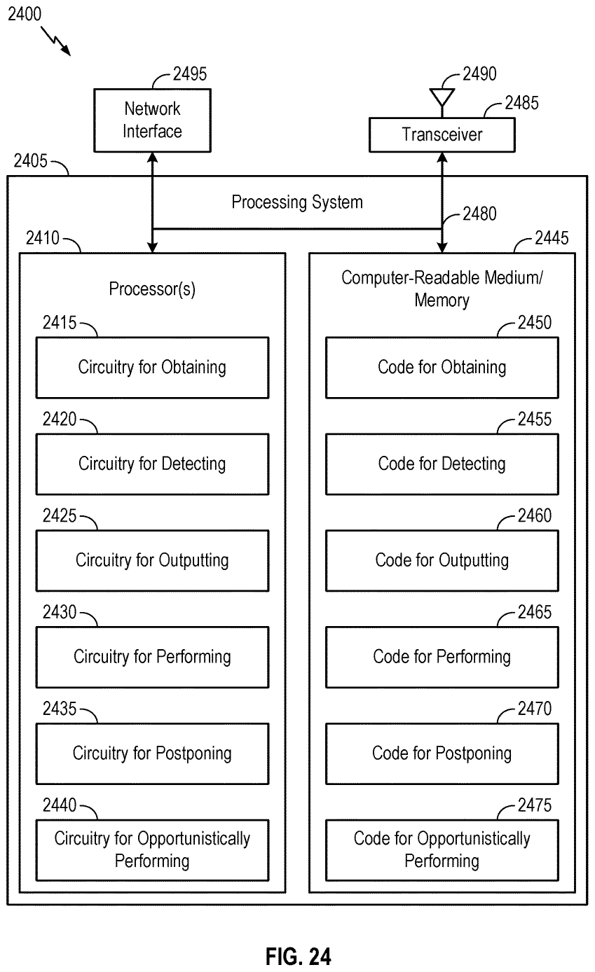

Method 2200 begins at step 2205 with obtaining first signaling configuring the wireless node to perform data collection responsive to detection of one or more events by the wireless node, wherein the first signaling configures the wireless node to perform the data collection according to a first configuration. In some cases, the operations of this step refer to, or may be performed by, circuitry for obtaining and/or code for obtaining as described with reference to FIG. 24.

Method 2200 then proceeds to step 2210 with detecting the one or more events. In some cases, the operations of this step refer to, or may be performed by, circuitry for detecting and/or code for detecting as described with reference to FIG. 24.

Method 2200 then proceeds to step 2215 with outputting second signaling indicating the detection. In some cases, the operations of this step refer to, or may be performed by, circuitry for outputting and/or code for outputting as described with reference to FIG. 24.

Method 2200 then proceeds to step 2220 with performing the data collection according to the first configuration, subject to availability of processing resources at the wireless node. In some cases, the operations of this step refer to, or may be performed by, circuitry for performing and/or code for performing as described with reference to FIG. 24.

In some aspects, the processing resources comprise channel state information (CSI) processing units (CPUs).

In some aspects, the second signaling indicates at least one of: an identifier (ID) of the first configuration or a measurement ID.

In some aspects, the method 2200 further includes outputting third signaling indicating the wireless node has stopped performing the data collection. In some cases, the operations of this step refer to, or may be performed by, circuitry for outputting and/or code for outputting as described with reference to FIG. 24.

In some aspects, the method 2200 further includes obtaining, after outputting the second signaling, third signaling that is configured to at least one of activate, deactivate, or reconfigure one or more of the first configuration. In some cases, the operations of this step refer to, or may be performed by, circuitry for obtaining and/or code for obtaining as described with reference to FIG. 24.

In some aspects, the second signaling further indicates that data collection is suspended due to insufficient processing resources available at the wireless node to perform the data collection.

In some aspects, the method 2200 further includes obtaining third signaling, after outputting the second signaling, that is designed to reduce current processing resource occupancy at the wireless node. In some cases, the operations of this step refer to, or may be performed by, circuitry for obtaining and/or code for obtaining as described with reference to FIG. 24.

In some aspects, the third signaling is configured to at least one of: deconfigure the data collection, postpone activation of one or more configurations, or deactivate one or more configurations.

In some aspects, the method 2200 further includes outputting a report after performing the data collection, wherein the report indicates at least one period during which the wireless node did not perform the data collection due to unavailability of sufficient processing resources. In some cases, the operations of this step refer to, or may be performed by, circuitry for outputting and/or code for outputting as described with reference to FIG. 24.

In some aspects, the second signaling comprises at least one of: a medium access control (MAC) control element (CE), control information, or assistance information.

In some aspects, the first signaling indicates priorities assigned to different configurations; and performing the data collection is also subject to a priority assigned to the first configuration.

In some aspects, the priorities assigned to the different configurations are associated with different actions.

In some aspects, the method 2200 further includes postponing or suspending the data collection if the first configuration is assigned a lower priority than a second configuration, if sufficient processing resources are not available to perform the data collection due to occupancy of processing resources by an action associated with the second configuration. In some cases, the operations of this step refer to, or may be performed by, circuitry for postponing and/or code for postponing as described with reference to FIG. 24.

In some aspects, the method 2200 further includes opportunistically performing the data collection if sufficient processing resources become available to perform the data collection. In some cases, the operations of this step refer to, or may be performed by, circuitry for opportunistically performing and/or code for opportunistically performing as described with reference to FIG. 24.

In some aspects, the method 2200 further includes obtaining third signaling, after outputting the second signaling, wherein the third signaling indicates a request for data logged at the wireless node. In some cases, the operations of this step refer to, or may be performed by, circuitry for obtaining and/or code for obtaining as described with reference to FIG. 24.

In some aspects, the method 2200 further includes outputting a report including the logged data responsive to the request. In some cases, the operations of this step refer to, or may be performed by, circuitry for outputting and/or code for outputting as described with reference to FIG. 24.

In one aspect, method 2200, or any aspect related to it, may be performed by an apparatus, such as communications device 2400 of FIG. 24, which includes various components operable, configured, or adapted to perform the method 2200.

Communications device 2400 is described below in further detail.

Note that FIG. 22 is just one example of a method, and other methods including fewer, additional, or alternative steps are possible consistent with this disclosure.

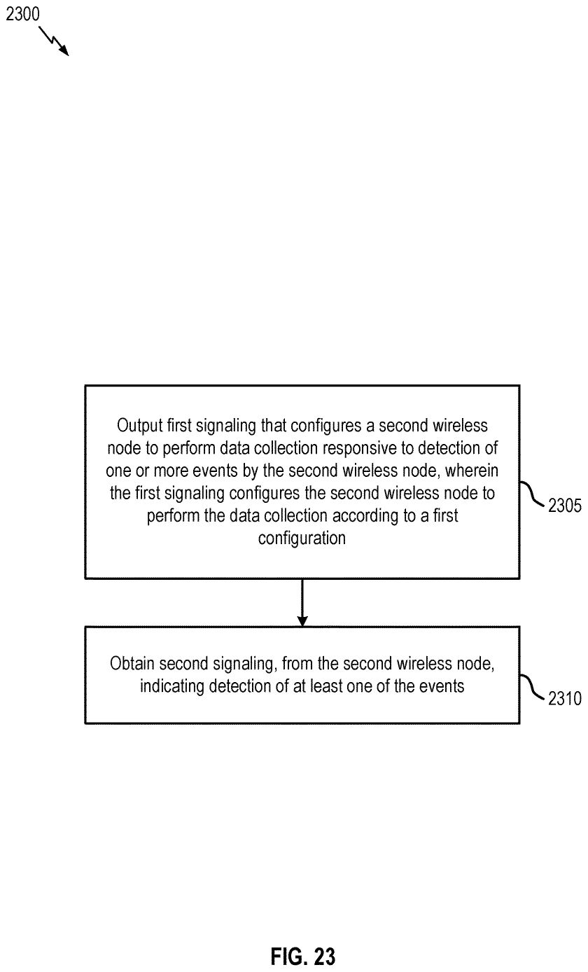

FIG. 23 shows an example of a method 2300 of wireless communications at a first wireless node, such as a BS 102 of FIGS. 1 and 3, or a disaggregated base station as discussed with respect to FIG. 2.

Method 2300 begins at step 2305 with outputting first signaling that configures a second wireless node to perform data collection responsive to detection of one or more events by the second wireless node, wherein the first signaling configures the second wireless node to perform the data collection according to a first configuration. In some cases, the operations of this step refer to, or may be performed by, circuitry for outputting and/or code for outputting as described with reference to FIG. 24.

Method 2300 then proceeds to step 2310 with obtaining second signaling, from the second wireless node, indicating detection of at least one of the events. In some cases, the operations of this step refer to, or may be performed by, circuitry for obtaining and/or code for obtaining as described with reference to FIG. 24.

In some aspects, the second signaling indicates availability of one or more channel state information (CSI) processing units (CPUs) at the second wireless node.

In some aspects, the second signaling further indicates an ID that is at least one of: associated with the first configuration or a measurement ID; and the method further comprises updating CPU occupancy metrics associated with the second wireless node based on the ID.

In some aspects, the method 2300 further includes obtaining third signaling indicating the second wireless node has stopped performing the data collection. In some cases, the operations of this step refer to, or may be performed by, circuitry for obtaining and/or code for obtaining as described with reference to FIG. 24.

In some aspects, the method 2300 further includes outputting fourth signaling that indicates a request for data logged at the second wireless node. In some cases, the operations of this step refer to, or may be performed by, circuitry for outputting and/or code for outputting as described with reference to FIG. 24.

In some aspects, the method 2300 further includes outputting third signaling, after obtaining the second signaling, that is configured to at least one of: activate, deactivate, or reconfigure the first configuration. In some cases, the operations of this step refer to, or may be performed by, circuitry for outputting and/or code for outputting as described with reference to FIG. 24.

In some aspects, the second signaling further indicates that data collection is suspended due to insufficient processing resources available at the second wireless node to perform the data collection.

In some aspects, the method 2300 further includes outputting, after obtaining the second signaling, third signaling that is designed to reduce current processing resource occupancy at the second wireless node. In some cases, the operations of this step refer to, or may be performed by, circuitry for outputting and/or code for outputting as described with reference to FIG. 24.

In some aspects, the third signaling is configured to at least one of: deconfigure the data collection, postpone activation of one or more configurations, or deactivate one or more configurations.

In some aspects, the method 2300 further includes obtaining a report that includes data logged at the second wireless node, wherein the report indicates at least one period during which the second wireless node did not perform the data collection due to unavailability of sufficient processing resources. In some cases, the operations of this step refer to, or may be performed by, circuitry for obtaining and/or code for obtaining as described with reference to FIG. 24.

In some aspects, the second signaling comprises at least one of: a medium access control (MAC) control element (CE), control information, or assistance information.

In some aspects, the first signaling indicates priorities assigned to different configurations.

In some aspects, different priorities assigned to different configurations are associated with different actions.

In some aspects, the method 2300 further includes outputting third signaling, after obtaining the second signaling, wherein the third signaling indicates a request for data logged at the second wireless node. In some cases, the operations of this step refer to, or may be performed by, circuitry for outputting and/or code for outputting as described with reference to FIG. 24.

In some aspects, the method 2300 further includes obtaining a report with the logged data after outputting the third signaling. In some cases, the operations of this step refer to, or may be performed by, circuitry for obtaining and/or code for obtaining as described with reference to FIG. 24.

In one aspect, method 2300, or any aspect related to it, may be performed by an apparatus, such as communications device 2400 of FIG. 24, which includes various components operable, configured, or adapted to perform the method 2300. Communications device 2400 is described below in further detail.

Note that FIG. 23 is just one example of a method, and other methods including fewer, additional, or alternative steps are possible consistent with this disclosure.

### Example Communications Device(s)

FIG. 24 depicts aspects of an example communications device 2400. In some aspects, communications device 2400 is a user equipment, such as UE 104 described above with respect to FIGS. 1 and 3. In some aspects, communications device 2400 is a network entity, such as BS 102 of FIGS. 1 and 3, or a disaggregated base station as discussed with respect to FIG. 2.

The communications device 2400 includes a processing system 2405 coupled to the transceiver 2485 (e.g., a transmitter and/or a receiver). In some aspects (e.g., when communications device 2400 is a network entity), processing system 2405 may be coupled to a network interface 2495 that is configured to obtain and send signals for the communications device 2400 via communication link(s), such as a backhaul link, midhaul link, and/or fronthaul link as described herein, such as with respect to FIG. 2. The transceiver 2485 is configured to transmit and receive signals for the communications device 2400 via the antenna 2490, such as the various signals as described herein. The processing system 2405 may be configured to perform processing functions for the communications device 2400, including processing signals received and/or to be transmitted by the communications device 2400.

The processing system 2405 includes one or more processors 2410. In various aspects, the one or more processors 2410 may be representative of one or more of receive processor 358, transmit processor 364, TX MIMO processor 366, and/or controller/processor 380, as described with respect to FIG. 3. In various aspects, one or more processors 2410 may be representative of one or more of receive processor 338, transmit processor 320, TX MIMO processor 330, and/or controller/processor 340, as described with respect to FIG. 3. The one or more processors 2410 are coupled to a computer-readable medium/memory 2445 via a bus 2480. In certain aspects, the computer-readable medium/memory 2445 is configured to store instructions (e.g., computer-executable code) that when executed by the one or more processors 2410, cause the one or more processors 2410 to perform the method 2200 described with respect to FIG. 22, or any aspect related to it; and the method 2300 described with respect to FIG. 23, or any aspect related to it. Note that reference to a processor performing a function of communications device 2400 may include one or more processors 2410 performing that function of communications device 2400.

In the depicted example, computer-readable medium/memory 2445 stores code (e.g., executable instructions), such as code for obtaining 2450, code for detecting 2455, code for outputting 2460, code for performing 2465, code for postponing 2470, and code for opportunistically performing 2475. Processing of the code for obtaining 2450, code for detecting 2455, code for outputting 2460, code for performing 2465, code for postponing 2470, and code for opportunistically performing 2475 may cause the communications device 2400 to perform the method 2200 described with respect to FIG. 22, or any aspect related to it; and the method 2300 described with respect to FIG. 23, or any aspect related to it.

The one or more processors 2410 include circuitry configured to implement (e.g., execute) the code stored in the computer-readable medium/memory 2445, including circuitry for obtaining 2415, circuitry for detecting 2420, circuitry for outputting 2425, circuitry for performing 2430, circuitry for postponing 2435, and circuitry for opportunistically performing 2440. Processing with circuitry for obtaining 2415, circuitry for detecting 2420, circuitry for outputting 2425, circuitry for performing 2430, circuitry for postponing 2435, and circuitry for opportunistically performing 2440 may cause the communications device 2400 to perform the method 2200 described with respect to FIG. 22, or any aspect related to it; and the method 2300 described with respect to FIG. 23, or any aspect related to it.

Various components of the communications device 2400 may provide means for performing the method 2200 described with respect to FIG. 22, or any aspect related to it; and the method 2300 described with respect to FIG. 23, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2485 and the antenna 2490 of the communications device 2400 in FIG. 24. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2485 and the antenna 2490 of the communications device 2400 in FIG. 24.

### Example Clauses

Implementation examples are described in the following numbered clauses:
Clause 1: A method for wireless communications at a wireless node, comprising: obtaining first signaling configuring the wireless node to perform data collection responsive to one or more events, wherein the first signaling configures the wireless node to perform the data collection according to a first configuration; detecting the one or more events; outputting second signaling indicating the detection; and performing the data collection according to the first configuration, subject to availability of processing resources at the wireless node.
Clause 2: The method of Clause 1, wherein the processing resources comprise channel state information (CSI) processing units (CPUs).
Clause 3: The method of any one of Clauses 1-2, further comprising detecting the one or more events, wherein the second signaling indicates at least one of: an identifier (ID) of the first configuration or a measurement ID.
Clause 4: The method of any one of Clauses 1-3, further comprising outputting third signaling indicating the wireless node has stopped performing the data collection.
Clause 5: The method of any one of Clauses 1-4, further comprising obtaining, after outputting the second signaling, third signaling being configured to at least one of activate, deactivate, or reconfigure one or more of the first configuration.
Clause 6: The method of any one of Clauses 1-5, wherein the second signaling further indicates that data collection is suspended due to insufficient processing resources available at the wireless node to perform the data collection.
Clause 7: The method of Clause 6, further comprising obtaining third signaling, after outputting the second signaling, being designed to reduce current processing resource occupancy at the wireless node.
Clause 8: The method of Clause 7, wherein the third signaling is configured to at least one of: deconfigure the data collection, postpone activation of one or more configurations, or deactivate one or more configurations.
Clause 9: The method of any one of Clauses 1-8, further comprising outputting a report after performing the data collection, wherein the report indicates at least one period during which the wireless node did not perform the data collection due to unavailability of sufficient processing resources.
Clause 10: The method of any one of Clauses 1-9, wherein the second signaling comprises at least one of: a medium access control (MAC) control element (CE), control information, or assistance information.
Clause 11: The method of any one of Clauses 1-10, wherein: the first signaling indicates priorities assigned to different configurations; and performing the data collection is also subject to a priority assigned to the first configuration.
Clause 12: The method of Clause 11, wherein the priorities assigned to the different configurations are associated with different actions.
Clause 13: The method of Clause 11, further comprising: postponing or suspending the data collection if the first configuration is assigned a lower priority than a second configuration, if sufficient processing resources are not available to perform the data collection due to occupancy of processing resources by an action associated with the second configuration; and opportunistically performing the data collection if sufficient processing resources become available to perform the data collection.
Clause 14: The method of any one of Clauses 1-13, further comprising: obtaining third signaling, after outputting the second signaling, wherein the third signaling indicates a request for data logged at the wireless node; and outputting a report including the logged data responsive to the request.
Clause 15: A method for wireless communications at a first wireless node, comprising: outputting first signaling that configures a second wireless node to perform data collection responsive to detection of one or more events by the second wireless node, wherein the first signaling configures the second wireless node to perform the data collection according to a first configuration; and obtaining second signaling, from the second wireless node, indicating detection of at least one of the events.
Clause 16: The method of Clause 15, wherein the second signaling further indicates availability of one or more channel state information (CSI) processing units (CPUs) at the second wireless node.
Clause 17: The method of Clause 16, wherein: the second signaling further indicates an ID that is at least one of: associated with the first configuration or a measurement ID; and the method further comprises updating CPU occupancy metrics associated with the second wireless node based on the ID.
Clause 18: The method of any one of Clauses 15-17, further comprising: obtaining third signaling indicating the second wireless node has stopped performing the data collection; and outputting fourth signaling that indicates a request for data logged at the second wireless node.
Clause 19: The method of any one of Clauses 15-18, further comprising outputting third signaling, after obtaining the second signaling, being configured to at least one of: activate, deactivate, or reconfigure the first configuration.
Clause 20: The method of any one of Clauses 15-19, wherein the second signaling further indicates that data collection is suspended due to insufficient processing resources available at the second wireless node to perform the data collection.
Clause 21: The method of Clause 20, further comprising outputting, after obtaining the second signaling, third signaling being designed to reduce current processing resource occupancy at the second wireless node.
Clause 22: The method of Clause 21, wherein the third signaling is configured to at least one of: deconfigure the data collection, postpone activation of one or more configurations, or deactivate one or more configurations.
Clause 23: The method of any one of Clauses 15-22, further comprising obtaining a report that includes data logged at the second wireless node, wherein the report indicates at least one period during which the second wireless node did not perform the data collection due to unavailability of sufficient processing resources.
Clause 24: The method of any one of Clauses 15-23, wherein the second signaling comprises at least one of: a medium access control (MAC) control element (CE), control information, or assistance information.
Clause 25: The method of any one of Clauses 15-24, wherein: the first signaling indicates priorities assigned to different configurations.
Clause 26: The method of Clause 25, wherein different priorities assigned to different configurations are associated with different actions.
Clause 27: The method of any one of Clauses 15-26, further comprising: outputting third signaling, after obtaining the second signaling, wherein the third signaling indicates a request for data logged at the second wireless node; and obtaining a report with the logged data after outputting the third signaling.
Clause 28: An apparatus, comprising: at least one memory comprising executable instructions; and at least one processor configured to execute the executable instructions and cause the apparatus to perform a method in accordance with any combination of Clauses 1-27.
Clause 29: An apparatus, comprising means for performing a method in accordance with any combination of Clauses 1-27.
Clause 30: A non-transitory computer-readable medium comprising executable instructions that, when executed by at least one processor of an apparatus, cause the apparatus to perform a method in accordance with any combination of Clauses 1-27.
Clause 31: A computer program product embodied on a computer-readable storage medium comprising code for performing a method in accordance with any combination of Clauses 1-27.
Clause 32: A first wireless node (e.g., a user equipment (UE)), comprising: at least one transceiver, at least one memory comprising instructions; and at least one processor configured to execute the instructions and cause the apparatus to perform a method in accordance with any combination of Clauses 1-14, wherein the at least one transceiver configured to receive the first signaling.
Clause 33: A second wireless node (e.g., a network entity), comprising: at least one transceiver, at least one memory comprising instructions; and at least one processor configured to execute the instructions and cause the apparatus to perform a method in accordance with any combination of Clauses 15-27, wherein the at least one transceiver configured to transmit the first signaling.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for obtaining, means for updating, means for detecting, means for outputting, means for performing, means for postponing, means for deconfiguring, means for deactivating, and means for opportunistically performing may comprise one or more processors, such as one or more of the processors described above with reference to FIG. 24.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
at least one transceiver;
at least one memory comprising computer-executable instructions; and
one or more processors configured to execute the computer-executable instructions to cause the apparatus to:
receive, via the at least one transceiver, first signaling configuring the apparatus to perform data collection responsive to one or more events, wherein the first signaling configures the apparatus to perform the data collection according to a first configuration;
transmit, via the at least one transceiver, second signaling indicating at least one of an identifier (ID) of the first configuration or a measurement ID; and
perform the data collection according to the first configuration, subject to availability of processing resources at the apparatus.

2. The apparatus of claim 1, wherein the processing resources comprise channel state information (CSI) processing units (CPUs).

3. The apparatus of claim 1, wherein:
the one or more processors are further configured to cause the apparatus to detect the one or more events; and
the second signaling is transmitted after the detection and indicates the detection.

4. The apparatus of claim 1, wherein the one or more processors are further configured to cause the apparatus to transmit, via the at least one transceiver, third signaling indicating the apparatus has stopped performing the data collection.

5. The apparatus of claim 1, wherein the one or more processors are further configured to cause the apparatus to receive, via the at least one transceiver after transmitting the second signaling, third signaling being configured to at least one of activate, deactivate, or reconfigure one or more of the first configuration.

6. The apparatus of claim 1, wherein the second signaling further indicates that data collection is suspended due to insufficient processing resources available at the apparatus to perform the data collection.

7. The apparatus of claim 6, wherein the one or more processors are further configured to cause the apparatus to receive third signaling, via the at least one transceiver after transmitting the second signaling, wherein the third signaling is designed to reduce current processing resource occupancy at the apparatus.

8. The apparatus of claim 7, wherein the third signaling is configured to at least one of: deconfigure the data collection, postpone activation of one or more configurations, or deactivate one or more configurations.

9. The apparatus of claim 1, wherein the one or more processors are further configured to cause the apparatus to transmit, via the at least one transceiver, a report after performing the data collection, wherein the report indicates at least one period during which the apparatus did not perform the data collection due to unavailability of sufficient processing resources.

10. The apparatus of claim 1, wherein the second signaling comprises at least one of: a medium access control (MAC) control element (CE), control information, or assistance information.

11. The apparatus of claim 1, wherein:
the first signaling indicates priorities assigned to different configurations; and
performing the data collection is also subject to a priority assigned to the first configuration.

12. The apparatus of claim 11, wherein the priorities assigned to the different configurations are associated with different actions.

13. The apparatus of claim 11, wherein the one or more processors are further configured to cause the apparatus to:
postpone or suspend the data collection if the first configuration is assigned a lower priority than a second configuration, if sufficient processing resources are not available to perform the data collection due to occupancy of processing resources by an action associated with the second configuration; and
opportunistically perform the data collection if sufficient processing resources become available to perform the data collection.

14. The apparatus of claim 1, wherein the one or more processors are further configured to cause the apparatus to:
receive third signaling, via the at least one transceiver after transmitting the second signaling, wherein the third signaling indicates a request for data logged at the apparatus; and
transmit, via the at least one transceiver, a report including the data logged responsive to the request.

15. The apparatus of claim 1, wherein the apparatus is configured to operate as a user equipment (UE).

16. An apparatus for wireless communications, comprising:
at least one transceiver;
at least one memory comprising computer-executable instructions; and
one or more processors configured to execute the computer-executable instructions to cause the apparatus to:
transmit, via the at least one transceiver, first signaling that configures a wireless node to perform data collection responsive to detection of one or more events by the wireless node, wherein the first signaling configures the wireless node to perform the data collection according to a first configuration; and
receive, from the wireless node via the at least one transceiver, second signaling indicating at least one of an identifier (ID) associated with the first configuration or a measurement ID.

17. The apparatus of claim 16, wherein the second signaling further indicates availability of one or more channel state information (CSI) processing units (CPUs) at the wireless node.

18. The apparatus of claim 17, wherein:
the one or more processors are further configured to cause the apparatus to update CPU occupancy metrics associated with the wireless node based on the ID.

19. The apparatus of claim 16, wherein the one or more processors are further configured to cause the apparatus to:
receive, via the at least one transceiver, third signaling indicating the wireless node has stopped performing the data collection; and
transmit, via the at least one transceiver, fourth signaling that indicates a request for data logged at the wireless node.

20. The apparatus of claim 16, wherein the one or more processors are further configured to cause the apparatus to transmit, via the at least one transceiver after receiving the second signaling, third signaling being configured to at least one of: activate, deactivate, or reconfigure the first configuration.
